(19) United States
(12) Patent Application Publication
(10) Pub. No.: US 2005/0055238 A1
(43) Pub. Date: Mar. 10, 2005

(54) Method for automated individual transition planning, execution and management

(76) Inventors: Dennis E. Wisnosky, Naperville, IL (US); John E. Conway, Westmont, IL (US); Steven T. Kroll, Lake Forest, IL (US); Margaret A. Lawlor, Elmhurst, IL (US); Sarah V. Letnes, Naperville, IL (US); Thad C. Letnes, Naperville, IL (US); Philip J. Vitkus, Aurora, IL (US); Joseph M. Vogel, Carpentersville, IL (US); Jeannine D. Wisnosky Stehlin, Culver City, CA (US)

Correspondence Address: Robert A. Brown, P.O. Box 2127, Northbrook, IL, 60065-2127, US

(21) Appl. No.: 10/937,614

(22) Filed: Sep. 9, 2004

Related U.S. Application Data
(60) Provisional application No. 60/501,379, filed on Sep. 9, 2003.

(51) Int. Cl. G06F 17/60

(52) U.S. Cl. 705/1

(57) ABSTRACT

The present invention relates to a method and process for the automated gathering, maintaining and delivering of knowledge, information and capabilities about the services, products and offerings of so called Community and/or School Service Providers (CSSP). The invention provides a computerized and automated blueprint to an Individual Education Plan (IEP) committee for a Special Education Student during the creation of the Individual Transition Plan (ITP) required by various laws and regulations enacted by the United States Federal and local State Governments that are pertinent to the Special Education Community.

### CROSS REFERENCE TO RELATED APPLICATION

This patent application claims priority from U.S. Provisional application Ser. No. 60/501,379, filed on Sep. 9, 2003, the entire contents of which are incorporated by reference herein.

### BACKGROUND OF THE INVENTION

The present invention relates to a method and process for the automated gathering, maintaining and delivering of knowledge, information and capabilities about the services, products and offerings of so called Community and/or School Service Providers (CSSP). The invention provides a necessary blueprint to an Individual Education Plan (IEP) committee for a Special Education Student during the creation of the Individual Transition Plan (ITP) required by various laws and regulations enacted by the United States Federal and local State Governments that are pertinent to the Special Education Community.

More particularly, the specific embodiment of the invention, known as Wizdom EducationLive!© computerizes and Automates this process.

Recently enacted legislation, such as the United States Individuals with Disabilities in Education Act (IDEA), the No Child Left Behind Act (NCLB) and other similar laws specify how Individual Transition Plans (ITP) are to be developed and maintained by the Individual Education Plan (IEP) committee of a Special Education Student during the time between when the student is 14.5 years of age and when the student completes high school or turns either 21 or 26 years of age depending on the State of Residence of the student.

Preparation of this ITP requires that School District personnel, usually a counselor, teacher, or coordinator, match the needs and preferences of the students with the CSSP best suited to provide those needs. Community Services Providers, from their point of view, are looking for individuals or clients who are in need of their services.

The old method of accomplishing the match between the needs of students (the required services), and the capabilities of Service Providers (the offered services) was an entirely manual process. In many cases it is in fact, not possible to do this correctly or to verify that it was done at all.

The old method has the following disadvantages. There are students who cannot find the necessary and sufficient services and there are CSSPs, which cannot find an adequate base—even though both requirements can be fulfilled within the community at the same time. School system personnel are not trained to understand “Best Practice” requirements of either IDEA or NCLB for ITPS. School system personnel are not trained to understand the specifics of CSSP offerings. School System Personnel do not have time to adequately research CSSP offerings.

Parents have no visibility into the availability of CSSPs. Parents have no visibility into the student and CSSP matching process. CSSP offerings are constantly changing. CSSP personnel must market to each individual school district and sometimes to individual school personnel and to parents and children. CSSP personnel do not understand their marketing role. When CSSP offerings change for either the short or long term, there is no way to adequately broadcast this information to those with the need.

### SUMMARY OF THE INVENTION

Therefore, it is a primary object of the present invention to provide a method and system to store the needs of students (the required services), gather, maintain and store the capabilities of Service Providers (the offered services) and to either manually or automatically match the required services with the offered services and to present the results of this match to all members of the user community either on demand on based upon predetermined rules over the Internet or an Intranet.

It is a further object of the present invention to provide a method and apparatus for the automated gathering, maintaining and delivering of knowledge, information and capabilities about the services, products and offerings of so called Community and/or School Service Providers (CSSP) as necessary to the Individual Education Plan (IEP) committee of a Special Education Student during the creation of the Individual Transition Plan (ITP) as required by various laws and regulations of the United States Federal and local State Governments. One advantage of the present invention is that it virtually automates the process of creating and maintaining information files about each Community and/or School Service Provider, assures their currency and monitors and manages their use without the active intervention of school district personnel.

### BRIEF DESCRIPTION OF THE DRAWING

The foregoing and other characteristics, objects, features and advantages of the present invention will become more apparent upon consideration of the following detailed description, having reference to the accompanying features of the drawing wherein:

FIG. 1 is a flow chart showing in general the method and process concept of the present invention.

FIG. 2 illustrates software components for execution and management of the method and process of the present invention.

FIG. 3 provides a diagrammatic flow chart for executing the method and process of the present invention including a repository for storage of information.

FIG. 4 shows a detailed data model of the repository depicted in FIG. 3 in an XML Schema mode.

FIG. 5 illustrates the manner in which a user is instructed how to start the method and process of the present invention.

FIG. 6A illustrates the manner in which instructions are provided to a user for CSSP entry of Service Provider Information into a Survey.

FIG. 6B illustrates the manner in which a User provides Service and Contact Information for CSSP Entry of Service Provider Information into a Survey.

FIG. 6C illustrates the manner in which a User provides further information for CSSP Entry of Service Provider Information into a Survey.

FIG. 6D illustrates the manner in which a User provides additional information for CSSP Entry of Service Provider Information into a Survey.

FIG. 6E illustrates the manner in which a User provides continued information for CSSP Entry of Service Provider Information into a Survey.

FIG. 6F illustrates the manner in which a User provides additional personal data information for CSSP Entry of Service Provider Information into a Survey.

FIG. 6G illustrates the manner in which a User provides additional documentation data information for CSSP Entry of Service Provider Information into a Survey.

FIG. 6H illustrates the manner in which a User provides contacting steps documentation data information for CSSP Entry of Service Provider Information into a Survey.

FIG. 6I illustrates the manner in which a User provides advice documentation data information for CSSP Entry of Service Provider Information into a Survey.

FIGS. 7A, 7B and 7C illustrate the manner in which CSSP may view Services and Services Categories and Data.

FIG. 8 depicts a District or Public View of Particular CSSP Information.

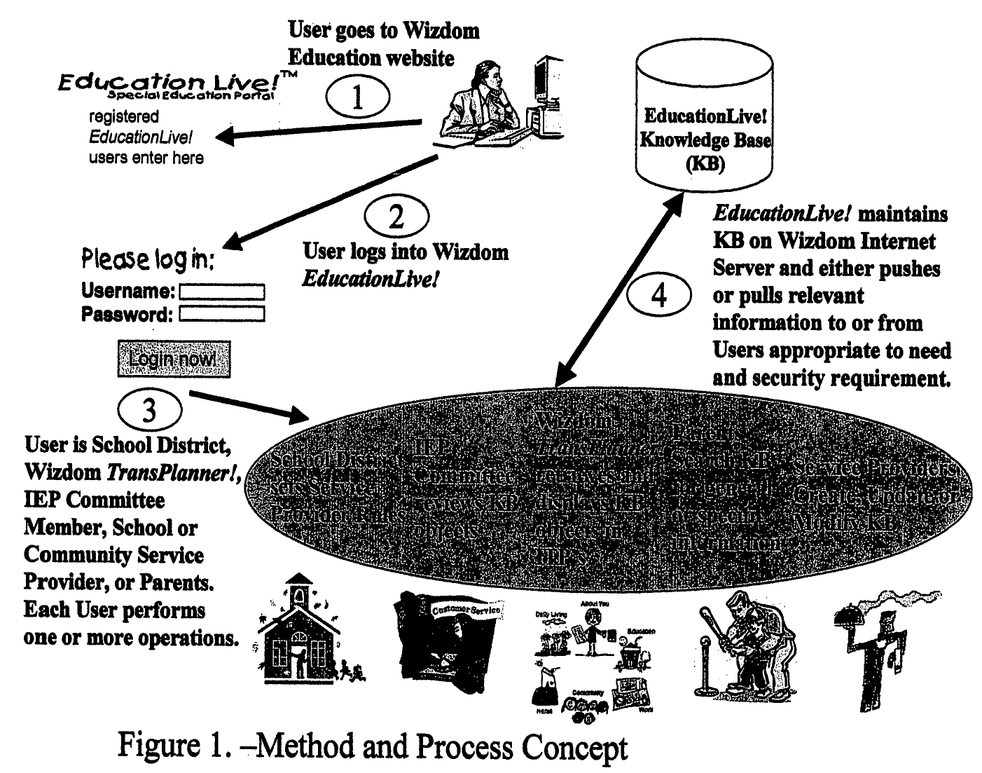

### DESCRIPTION OF A PREFERRED EMBODIMENT

Referring now to the figures of the drawing, there is shown a method and apparatus for automated gathering, maintaining and delivering knowledge, information and capabilities about the services, products and offerings of Community School Services Providers for use by an Individual Education Plan committee and applied to, for example, a Special Education Student. Providing such a method and apparatus has a number of distinct advantages.

First: “Best Practice” requirements of either IDEA, or NCLB for ITPs is built into and maintained by the method and process of the system. These Best Practices are reinforced to school district personnel automatically by the system.

Second: The specifics of CSSP offerings are built into and maintained by the method and process of the system. School system personnel do not need to understand these offerings in advance.

Third: CSSP offerings are maintained by the CSSPs. School System Personnel do not need to research and maintain information about these offerings.

Fourth: The availability of CSSPs and their offerings can be made known in real time to parents.

Fifth: The CSSP matching process can be made clear to parents.

Sixth: Constantly changing CSSP offerings are immediately reflected in the CSSP knowledge base. There is never a time when an IEP Committee meeting is stopped while research is conducted to find the appropriate CSSP.

Seventh: CSSP personnel need to maintain only their own knowledge base and it is automatically push marketed to each individual school district and to individual school personnel and to parents and children.

Eighth: CSSP Marketing is literally done by the method and process. There is no need for CSSP personnel to market their products and services beyond maintaining their information in the Knowledge Base.

Ninth: CSSP offering changes are automatically delivered to those with the need to know virtually instantaneously and reflected in all future ITPs.

Tenth: The mismatch between required needs and available services is exposed and can be eliminated because this information is available to all parties in real time and on a look ahead basis.

The Engineering Principle that makes this invention work successfully is the logic embedded in the matching engine, the logic embedded in the Info File (the offered services) generator combined with the use of Internet technology.

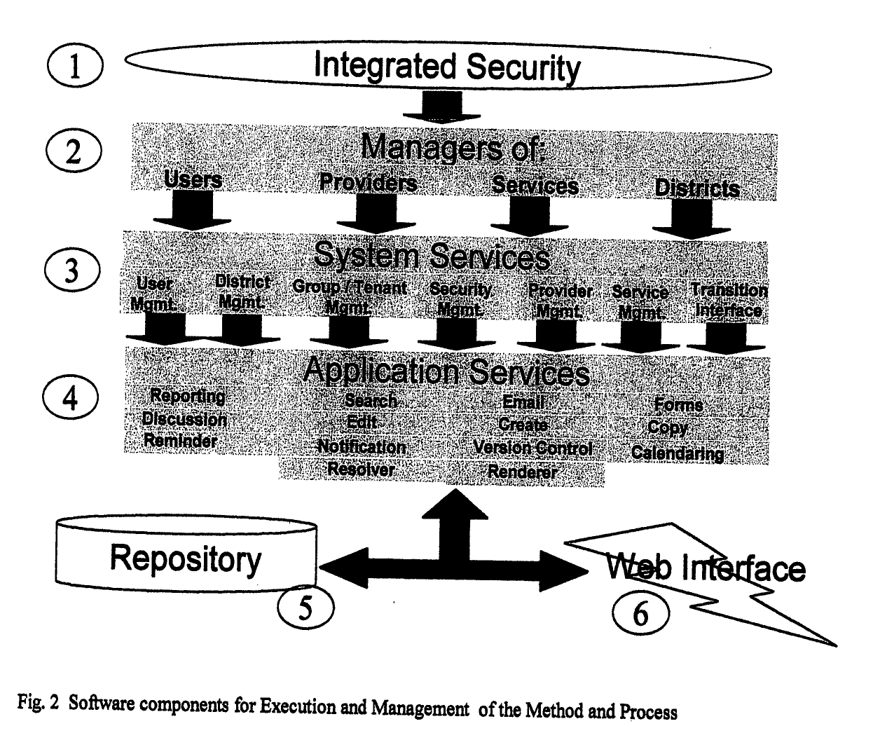

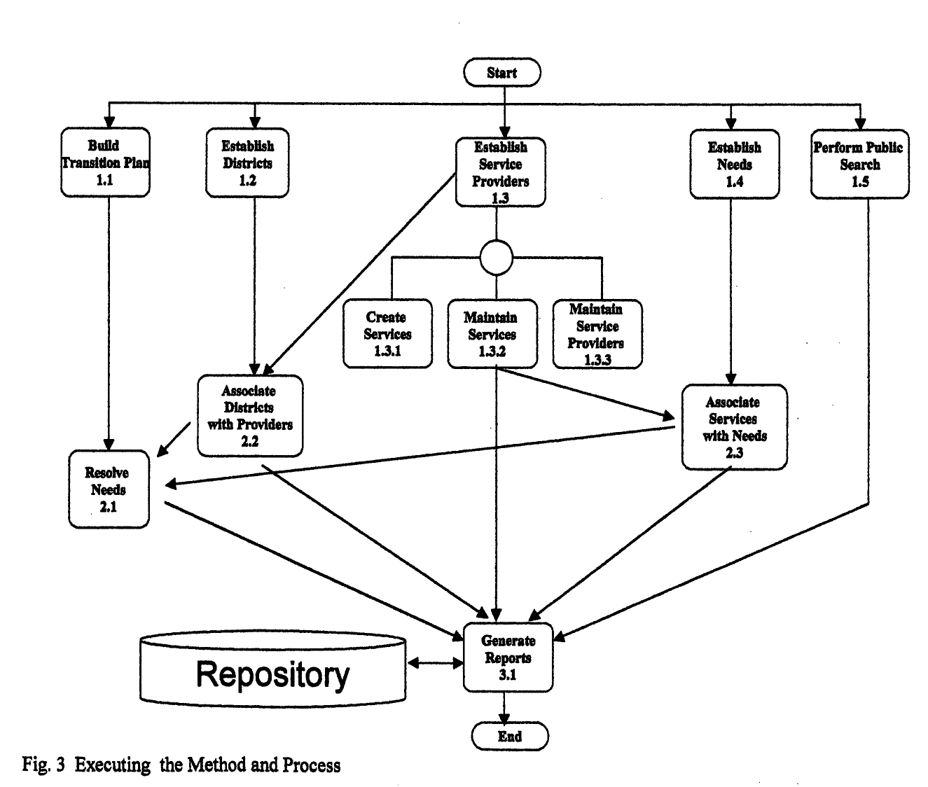

The illustration depicted in FIG. 2 shows the structural components of the present invention as hereinafter explained in detail.

21.1 System Security Services (1) provides entry permissions through a web-based log in. Permissions determine the specific access rights to the methods and process.

21.2 Managers (2) of Users, Providers, Services, and Districts provide authenticated access to the methods and processes of the system. There is no system known that integrates these permissions in a single system accessible through the web (6) integrated with a knowledge repository (5).

21.3 System Services (3) provides unique capabilities not available in any other method or system designed for this purpose, particularly in the services for District Management, Provider Management, Service Management and Transition Interface.

21.3.1 District Management is a function specifically designed for School District personnel to manage access to specific School or Community Service Providers. School District personnel can determine and preset details such as which CSSPs are available to ITPs and under what conditions they are available.

21.3.2 Provider Management is performed by EducationLive! Administration. This function determines which providers have access to EducationLive! and with which permission level. Through Provider Management, each individual CSSP has certain rights to add, modify or delete their own CSSP information. When information is changed, then the process notifies the other functions 21.3.1, 21.3.2 and 21.3.3. When information has not been changed for a period of time, 21.3.2 is notified by the other functions.

21.3.3 Services Management function is the domain of the CSSPs. As determined by 21.3.1 and 21.3.2, each CSSP has the ability to determine what services they will offer and under what conditions.

21.3.4 Transition Interface is an automatic connection to the Wizdom TransPlaner!, or similar software that performs the function of automatically capturing student Information and determining the specific needs of students.

21.4 Application Services (4) are accessed as necessary and appropriate by System Services (3). Applications Services perform specific unique functions both generic and specific to the particular task of the user. Unique to the method and process are:

21.4.1. Reminder performs the function of sending messages to Service Providers, and/or Districts when a determined amount of time has passed without activity with respect to updating either a service requirement or a service capability. Reminders are sent either as Alerts when a userlogs on to EducationLive!, or as an email, or both.

21.4.2 Notification notifies users when a significant event has occurred. For example, a CSSP may have changed some characteristic of its service offering. Notification will send an email to those users with permission to know this change.

21.4.3 Version Control maintains all versions of CSSP information files. The CSSP is able to copy all or part of past versions and/or to reuse all or part of past data or simply verify what was offered in the past and when it was offered.

21.4.4 Create converts CSSP information gathered through an on line survey and generates specific information files in a structured format which describes the CSSP offering in exact detail and stores it in the Knowledge Base.

21.4.5 Resolver compares the results of the student survey from the Wizdom TransPlanner! or the results of a public query and selects specific CSSP offerings to be rendered and/or reported to the human or software user.

21.4.6 Renderer presents the results determined by the revolver to the user in the desired form on a screen, in data, or in a report. Renderer also provides data in a structured format for use by other software and to the users in exactly the same format every time regardless of how CSSP surveys were completed.

21.5 Repository (5) maintains and contains the Knowledge Base relative to the needs of each of the Users, Providers, Services and Districts.

21.6 Web Interface (6) provides a user interface to EducationLive! services using omnipresent Internet technology.

The advantages of the structural construction of the system lie in both the operation of each of its unique functions individually, and the integration of its unique functions. There is no known method or process which performs any of the functions described herein for any one of the Users, Providers, Services and Districts. This method and process performs each of the functions for each of the Users, Providers, Services and Districts. Further, this method and process uses Internet based technology in performing these functions.

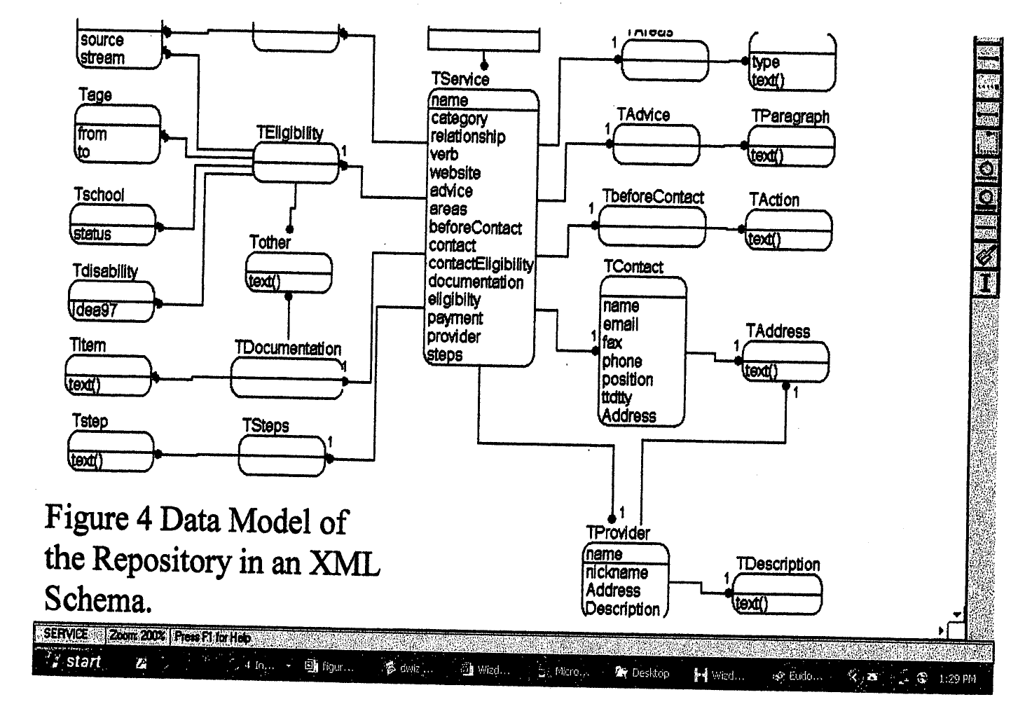

Referring specifically to FIG. 4, there is explained one complete cycle of operation of the method and process. System entry can be for 5 different purposes 1.1 Build Transition Plan, 1.2 Establish Districts, 1.3 Establish Service Providers, 1.4 Establish Needs and/or 1.5 Perform Public Search. Each of these purposes may or may not relate to the other and each could be contained within or be independent of a cycle of operation of any other. Accordingly, 5 cycles will be explained here.

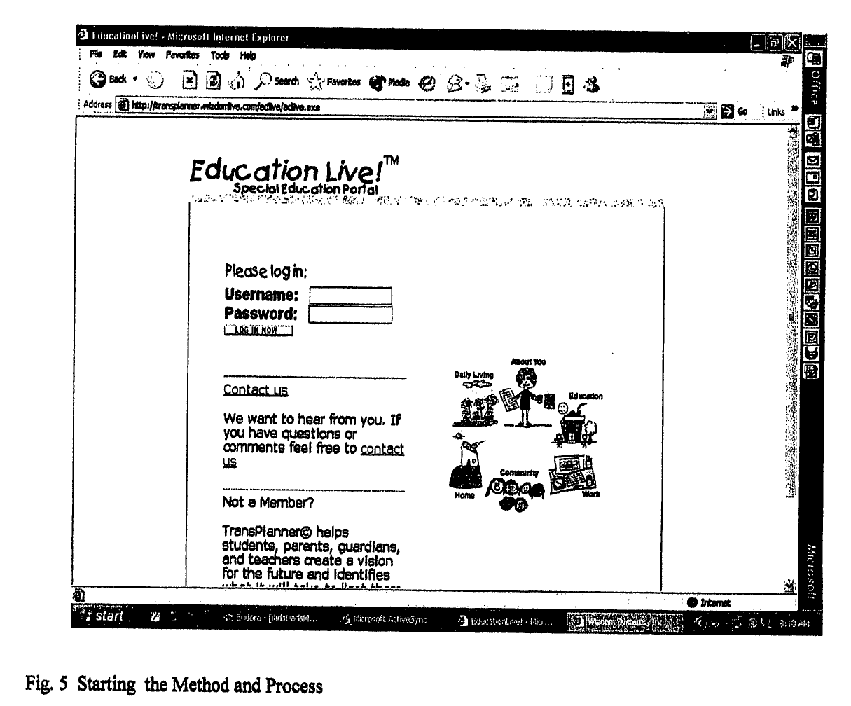

Start is entered through any Internet Browser as shown in FIG. 5. This entry point requires a specific assigned User Name and Pass Word.

23.1 Start goes to 1.1 Build Transition Plan which performs the task of building the ITP specific to the needs of the individual student. Build Transition Plan 1.1 is the interface between EducationLive! and the Transplanner! or any other software which could perform this task. Because the ITP must contain needs matched to service, there is the requirement to resolve these needs which is accomplished by task 2.1 Resolve Needs for the particular individual. This task 2.1 is fed the knowledge of how each service is associated with each need globally from the knowledge base in the repository, and how a specific school district wants to use a specific CSSP. Task 2.1 resolves these global needs to the particular need and CSSP combinations for the ITP and presents these results to 3.1 which generates the reports desired and which in turn complete the process for the cycle which began at 1.1 Build Transition Plan.

23.2 Start goes to 1.2 Establish Districts which performs the task of setting the existence and the rules for existence (permissions) for users within the districts. Based upon the rules established and the existence of service providers, 2.2 Associate Districts with Providers, will perform this association and present these results to 2.1 Resolve Needs to be incorporated in an ITP. Alternatively, 2.2 presents its district and provider association to 3.1 which generates the reports desired and which in turn complete the process for the cycle which began at 1.2 Establish Districts.

23.3 Start goes to 1.3 Establish Service Providers which performs the task of entering and maintaining each and all of the CSSP's in the Knowledge Base contained in the Repository. Initially, the system administrator enters the categories of services in to the Knowledge Base of the Repository depending upon the current rules of IDEA. This provides the basis for the individual CSSP to perform task 1.3.1 Create Services and Task 1.3.2 Maintain Services.

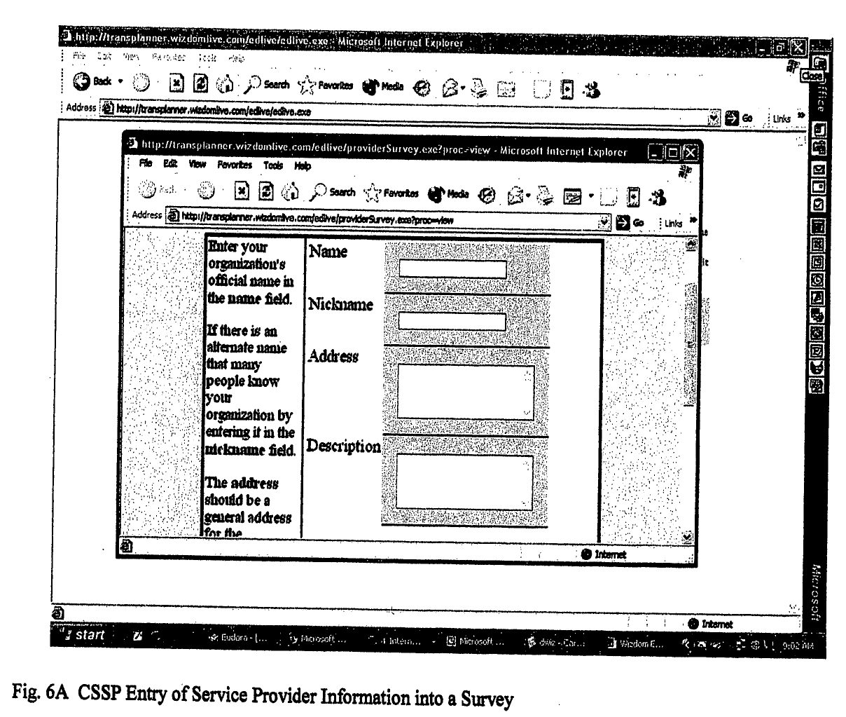

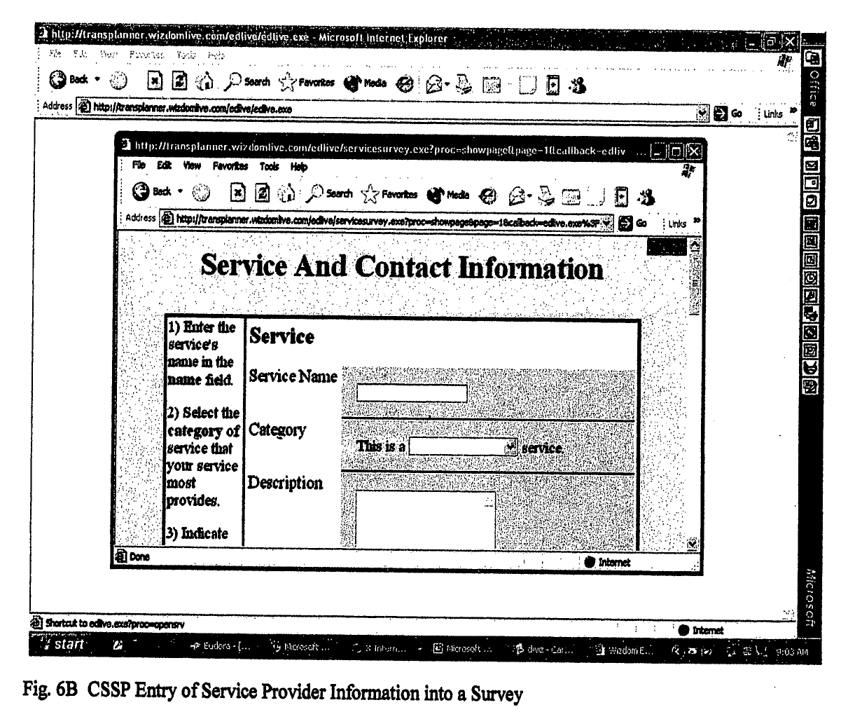

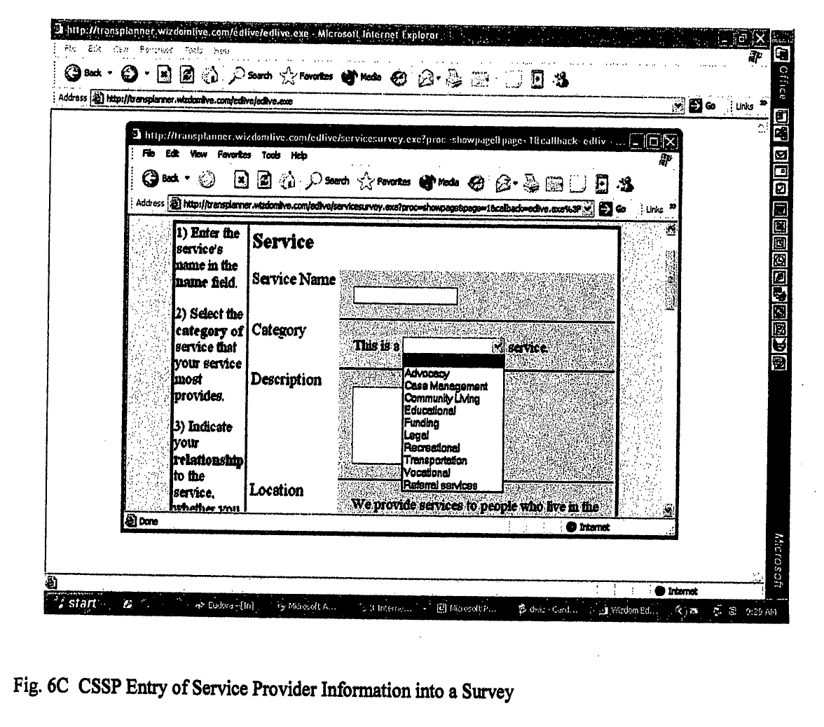

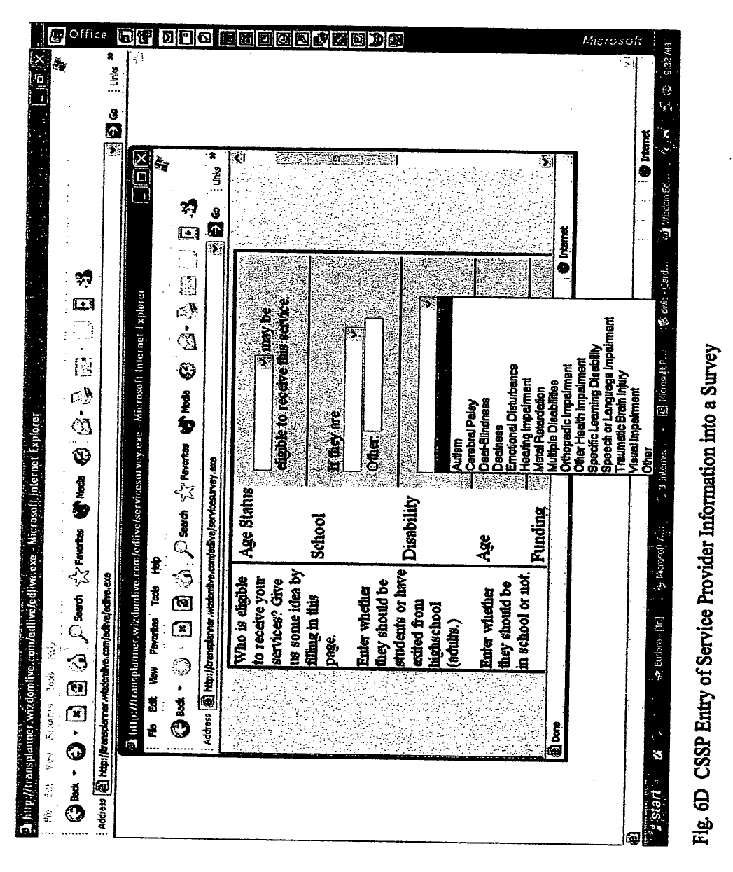

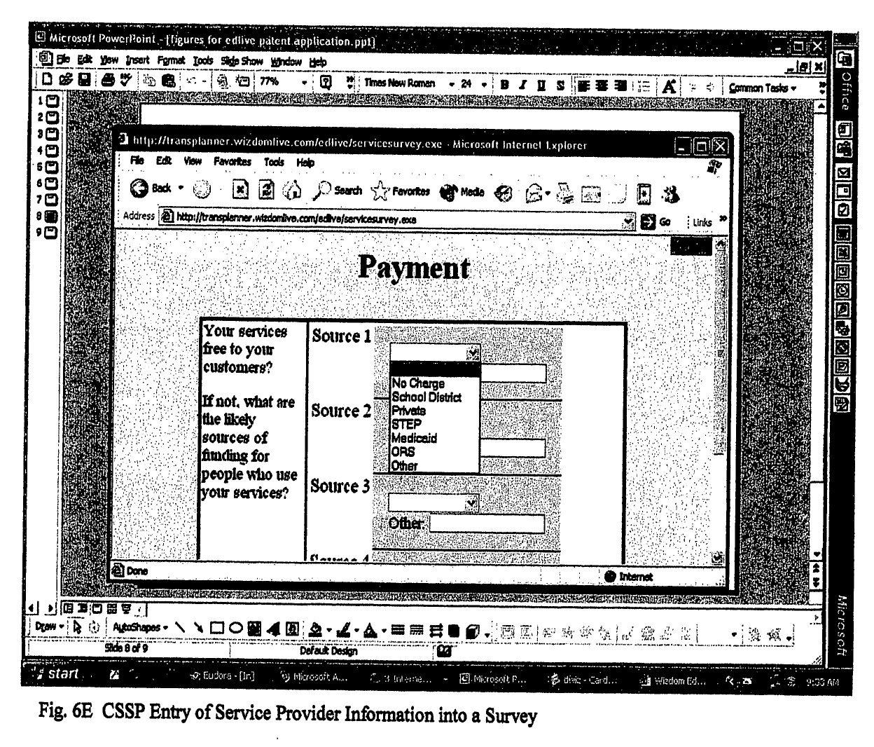

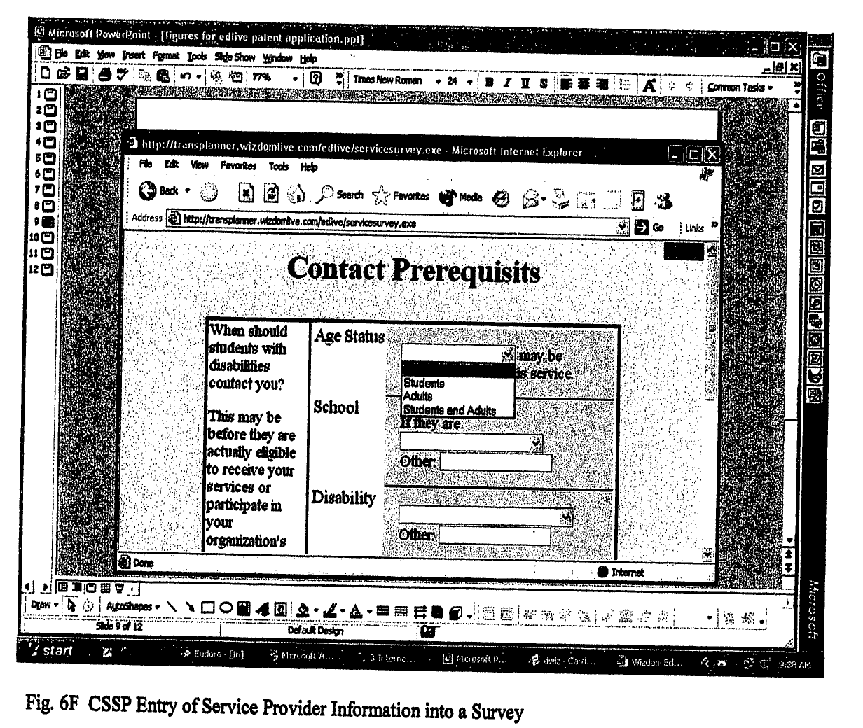

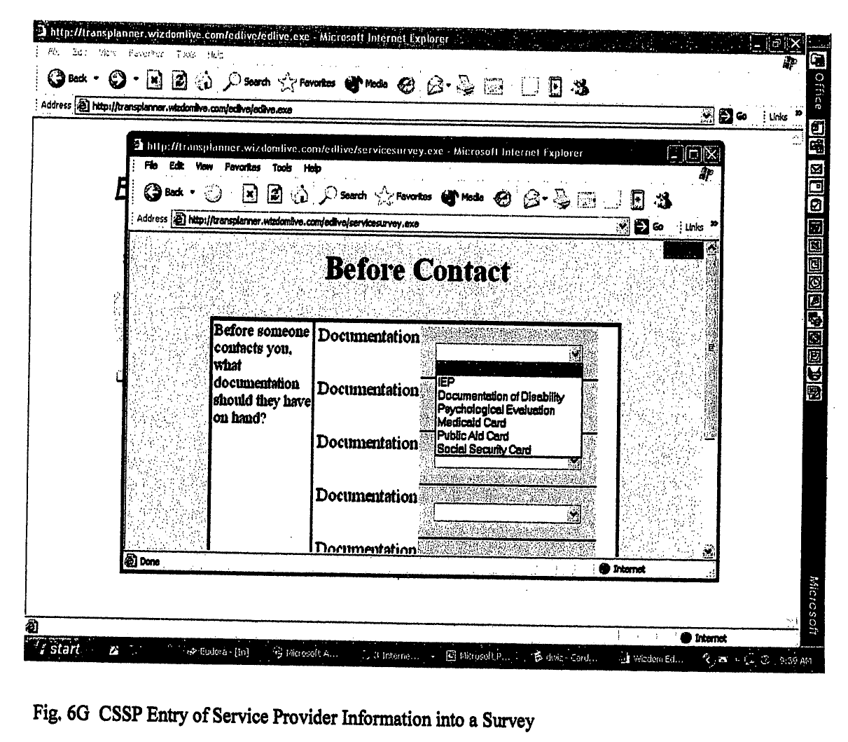

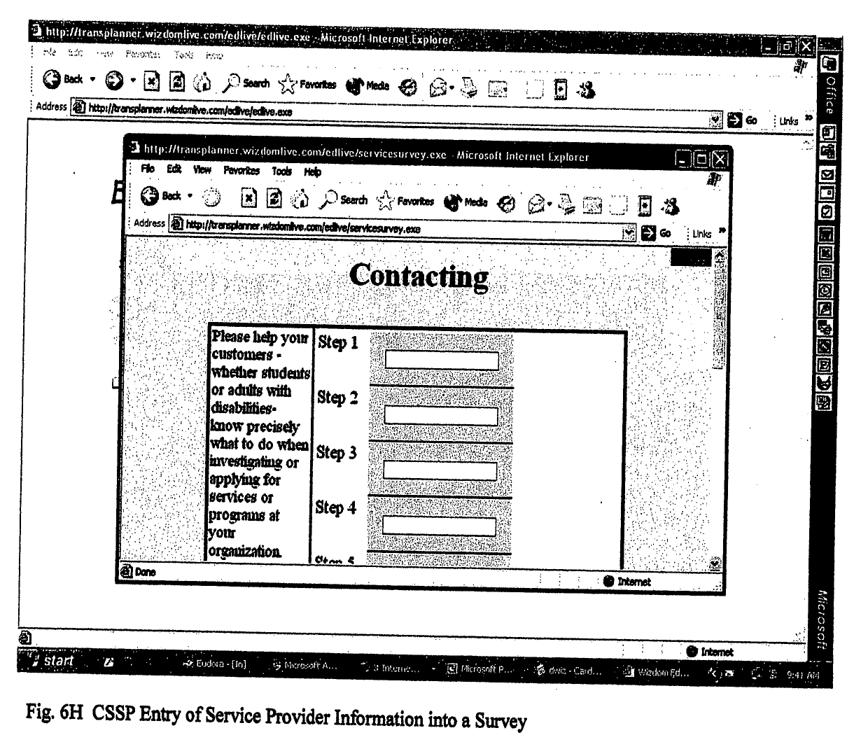

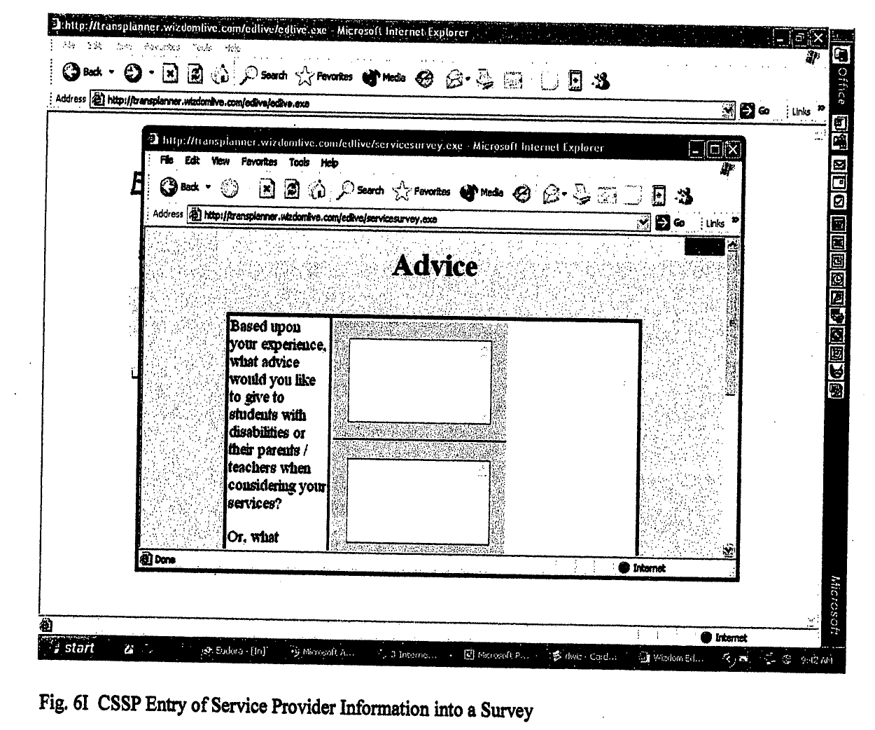

In Task 1.3.1, the CSSP completes a survey (See FIGS. 6A through 6I), which among other things, matches its service(s) to allowable Categories and then helps the CSSP to add specific and particular information such as eligibility, service area, payment method, etc. and to maintain this information current at any time.

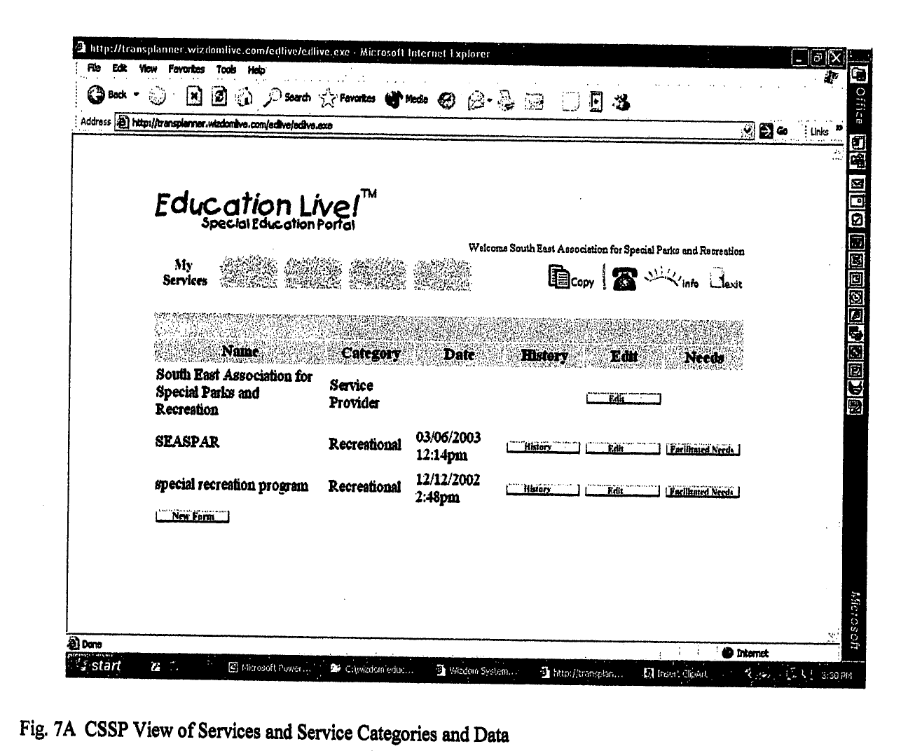

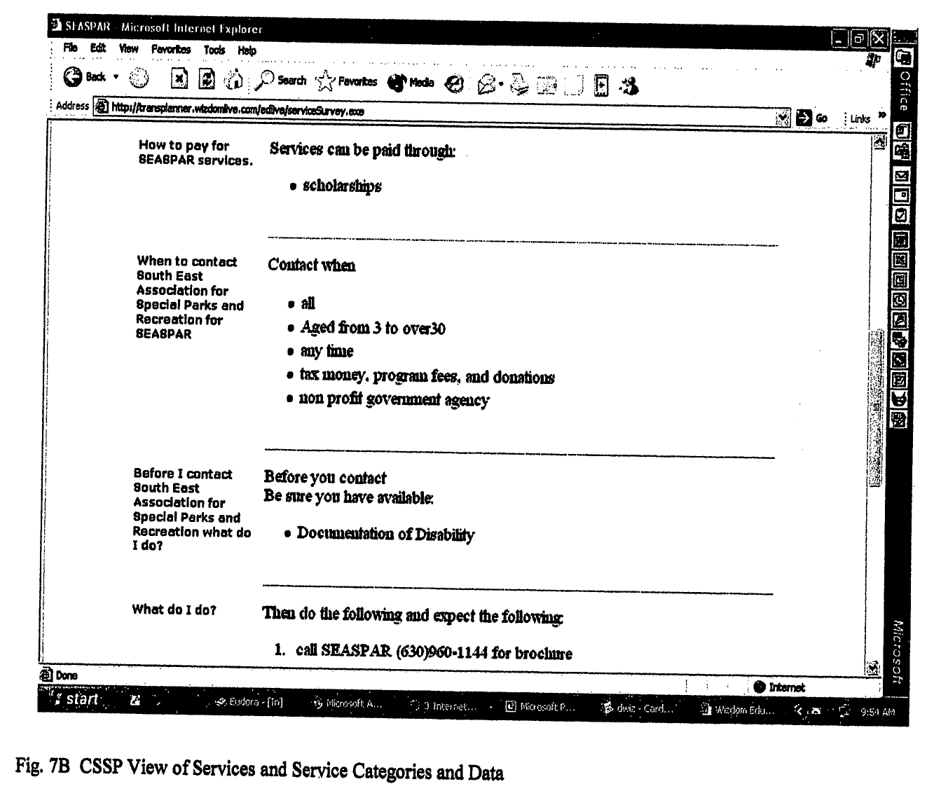

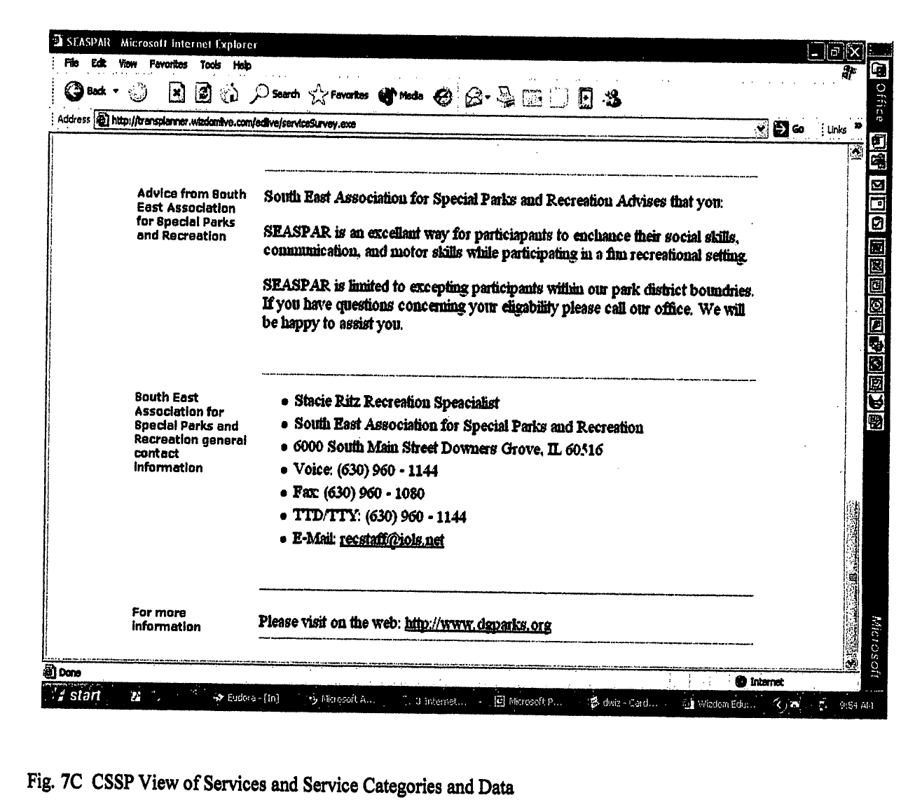

Task 1.3.2 Maintain Services allows the CSSP to view and to modify any property of any service at any time through the windows show in attached FIG. 7A through 7D. Additionally, at any point in time Task 2.3 may call Task 1.3.2 and request access to the Knowledge Base so that it can perform the task of Associating Services with Needs as required by Task 2.1 Resolve Needs. Task 1.3.3 Maintain Service Providers refers to the global process for maintaining the Knowledge Base particular to the universe of CSSPs. Alternatively and additionally, Task 3.1 Generate Reports may request a list of all CSSPs or any CSSP which completes the cycle that began at 1.3 Establish Service Providers.

23.4 Start goes to 1.4 Establish Needs which maintains the global list of needs as determined by the disabilities of the IDEA. This knowledge base is available to Task 2.3, Associate Services with Needs which performs this association based upon the dynamic requirements of 2.1 to Resolve Needs, and the continuously changing Knowledge Base of available services from 1.3.2. Alternatively and additionally, Task 3.1 Generate Reports may request a list of all CSSP's or any CSSP matched to the needs which it or they satisfy which completes the cycle that began at 1.4 Establish Needs.

23.5Start goes to 1.5 Perform Public Search which enables registered users to search the repository of the Knowledge Base for particular data and information which is presented to them by 3.1 Generate Reports which completes the cycle that began at 1.5 Perform Public Search.

23.6 The Knowledge Base is contained in a Repository following the general and specific schema shown below in the attached FIG. 4. The Repository is accessible by any task directly or though the Internet.

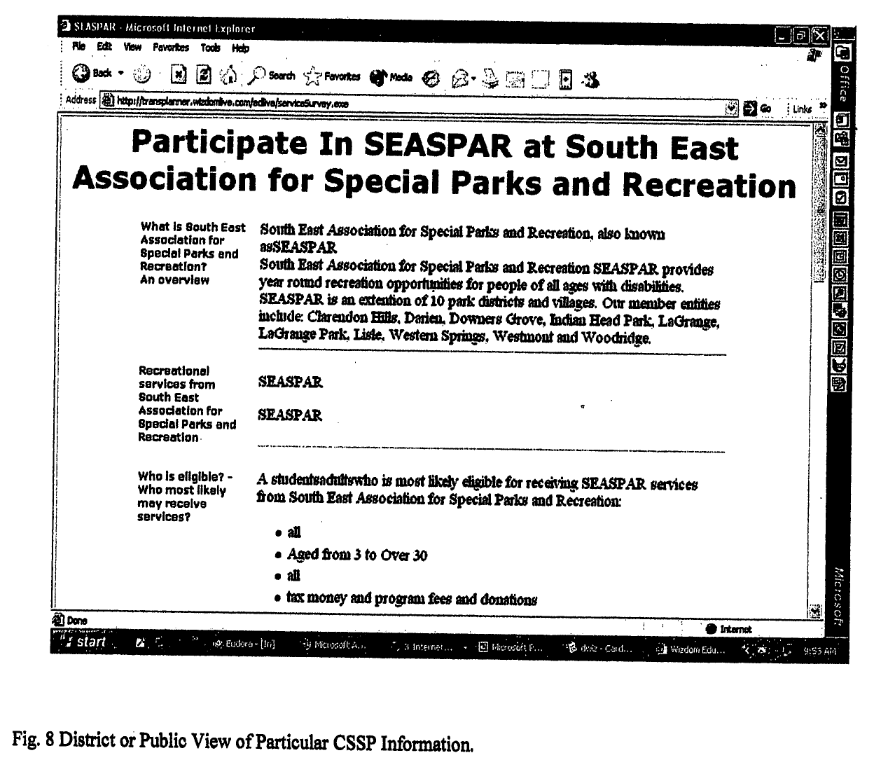

23.7 Generate Reports 3.1 generates various and many reports which may be either or both structured data for other Tasks or displays or printouts such as is shown in FIG. 8.

In the event any person skilled in the art, or otherwise, might attempt to change or reverse engineer small details of this method and process and try to perform any particular process in a somewhat different way technically, his or her effort could not change the method and process disclosed herein to achieve the same result in the same way accomplished by the present invention.

Concepts of using the Internet, building knowledge bases, performing searches, generating reports and completing surveys are, of course, not new in general. All other concepts disclosed in this application are new, operable and unobvious, as disclosed in this application.

From the foregoing it will be observed that numerous modifications and variations can be effectuated without departing from the true spirit and scope of the novel concepts of the present invention. It is to be understood that no limitation with respect to the specific embodiments illustrated is intended or should be inferred.

While the present invention has been described with reference to the above preferred embodiments, it will be understood by those skilled in the art, that various changes may be made and equivalency may be substituted for elements thereof without departing from the scope of the present invention. Therefore, it is intended that the invention not be limited to the particular embodiments disclosed for carrying out this invention, but that the present invention includes all embodiments falling within the scope of the appended claims.

1. A Method for automated collection of information about services of school providers offered to special education communities to formulate an individual education plan (IEP) for a special education student to comply with federal, state and local laws, comprising the steps of,
providing an internet website for receiving data from a supplier of special education services,
storing said data in a repository disposed within said web site,
instructing a user how to enter a preselected portion of said data stored in said repository for transformation into at least one survey,
extracting from said survey pertinent data to automatically formulate an implementable individual education plan and containing a transition plan appropriate for the needs of any individual selected special education student, and
using said individual education plan to educate and manage the activities of said selected special student.

2. A Method as claimed in claim 1 comprising the step of
reminding service providers and users of the need to update stored data after a predetermined time interval has transpired without use.

3. A Method as claimed in claim 1, comprising the steps of
notifying authorized users by e-mail of updated characteristics changes in service offerings from service providers.

4. A Method as claimed in claim 1, comprising the step of
providing to said user control of all versions of stored information data for future copying, reuse and verification as to time and date of receipt.

5. A Method as claimed in claim 1 comprising the step of
converting information gathered from an on line survey to generate specific information files in a structured format which describes said individual education plan in exact detail and stores it in a knowledge base.

6. A Method as claimed in claim 1 comprising the step of
comparing the results of a plurality of surveys through retrieval by a transplanner for display of knowledge base objects and to select specific offerings for an individual transition plan to be rendered to a human or software user.

7. A Method as claimed in claim 1 comprising the step of
rendering results extracted by said at least one survey to said user in a desired form on a screen, in data in a report in exactly the same format each time any one survey was completed.

8. A Method as claimed in claim 1 comprising the step of
maintaining in said repository a knowledge base relating and pertinent to needs of users, school providers, education districts and students.

9. A Method as claimed in claim 1 comprising the step of
providing within said internet website a user interface to maintain a knowledge base for service of push-pull relevant information to and from users directed to needs and security requirements using omnipresent internet technology.

10. A System for automated collection of information about services of school providers offered to special education communities to formulate an individual education plan for a special education student to comply with federal, state and local laws, comprising,
an internet education website operable to analyze and store information relating to required needs of an individual student,
said website adaptable to gather, maintain and store service data offered by school providers,
said website in response to a user request capable of automatically matching the required needs of said student with the services offered by said school providers,
whereby said user may submit results of said matching to all members of a user community.

11. A System as claimed in claim 10 wherein entry to said website comprises,
a specific assigned user name and password.

12. A System as claimed in claim 10 wherein entry to said website includes a plurality of operative functions, comprising
building of transation plans, establishing and maintaining a directory of service providers, establishment of districts, performance of public searches, completion of surveys, establishment of individual student needs, and generating reports.

13. A System as claimed in claim 10 wherein said website comprises,
a computer data base for receiving a description of special education services, for receiving needs of a selected individual special student, for determining an individual education plan for said student, and for generating an individual transition plan for the student.

14. A system as claimed in claim 13 wherein said computer data base comprises knowledge stored in a repository.

15. A system as claimed in claim 10 wherein said school provider comprises a view of services, service categories and data.

16. A system as claimed I claim 10 wherein said website comprises a view of a district and a public view of particular special education services.

17. A System as claimed in claim 10 wherein said website comprises a data base for district management, services management, transition interface and application services.
